(19) United States
(12) Patent Application Publication
(10) Pub. No.: US 2025/0083081 A1
(43) Pub. Date: Mar. 13, 2025

(54) PASSIVE DEHUMIDIFIER FOR ENVIRONMENT CONTROL UNITS

(71) Applicant: Textron Innovations, Inc., Providence, RI (US)

(72) Inventors: Robert Herkimer, Savannah, GA (US); Shahryar Fotovati, Frisco, TX (US); William R. Johnson, Colleyville, TX (US); Gary J. Coleman, JR., Fort Worth, TX (US)

(73) Assignee: Textron Innovations, Inc., Providence, RI (US)

(21) Appl. No.: 18/463,129

(22) Filed: Sep. 7, 2023

(51) Int. Cl. B01D 45/06; B01D 45/08

(52) U.S. Cl. CPC B01D 45/06; B01D 45/08

(57) ABSTRACT

Passive dehumidifiers for environmental control units (ECUs) are presented. In embodiments, the passive dehumidifier may include a plenum with an intake to receive an airflow with moisture (e.g., water droplets, water vapor, etc.) present. Upon entering the passive dehumidifier, the airflow may experience a reduction in inertia and a change from a first direction to a second direction. The directional change may be sharp enough (e.g., greater than 90 degrees) that the moisture in the airflow are not able to follow the airflow and are instead directed to impinge and be collected on a collector wall, which may include one or more hydrophilic surfaces facilitating the impinged water droplets to form a liquid film upon impact on the collector wall. The film may collapse due to gravity and may be drained out through and/or on a hydrophilic screen mesh (e.g., hydrophilic screen mesh surface) on the collector wall surface(s).

### STATEMENT REGARDING FEDERALLY SPONSORED RESEARCH OR DEVELOPMENT

This disclosure was made with Government support under Agreement No. W911W6-19-9-0002, awarded by the Army Contracting Command-Redstone Arsenal. The Government has certain rights in the invention.

### TECHNICAL FIELD

The present disclosure generally relates to environment control units (ECUs), and more specifically to passive dehumidifiers for ECUs.

### BACKGROUND

Controlling the environment within a space is a very powerful capability that is useful in very many and varied applications. Being able to control the temperature and/or the humidity of a relevant space can provide many benefits and prevent many problems. For example, controlling the temperature of a home can allow us to escape the outside heat and reside in a comfortable space. In the same manner, controlling the temperature and/or the humidity within the cabin of a vehicle (e.g., a car, an aircraft, etc.) can ensure a comfortable and safe environment for the operator of the vehicle. For example, a high humidity can cause aircraft canopies and instrumentation to become fogged and obscured with moisture and become unusable, limiting the pilot's visibility and leading to potential risks. In addition, high humidity within an aircraft cabin can cause water droplets or particles to accumulate and cause equipment damage, or cause the pilot to become damp.

Current environmental control units (ECUs) are used to manage the environmental conditions within a space. The ECU performs this task by drawing in ambient air, adjusting its temperature (either cooling or heating), and removing excess moisture or humidity before returning the conditioned air to the space of interest. However, current ECUs are limited in their ability to remove humidity from intake air and typically, a significant amount of water droplets remain in the conditioned air. For example, FIG. 1 illustrates an example of a typical ECU 50 configured to condition intake air and remove humidity from the intake air.

As shown in FIG. 1, ECU 50 includes blower 52 and evaporator 54. Blower 52 may be configured to push or blow warm air 56 onto evaporator 54. Warm air 56 may flow through evaporator 54 and may be cool down by evaporator 54. Cool air 57 may then flow out of evaporator 54 onto a vehicle cabin. In this implementation, evaporator 54 may also function to remove humidity or moisture from warm air 56. For example, in the process of cooling down warm air 56, some of the moisture within warm air 56 may condense into water droplets within evaporator 54. The water droplets may then be routed through drainage 58 out of ECU 50.

However, ECU 50, and in fact current ECUs in general, is not able to remove all humidity from warm air 56 and a significant portion of water droplets typically remain in cool air 57. This water droplets are taken into the cabin by cool air 57 and may cause a host of problems as mentioned above. The reason for the water droplets remaining in cool air 57 may include the high inertia of the airflow through evaporator 54, which in some applications may be 200-400 cubic feet per minute. As water droplets within the airflow through evaporator 54 are bulky, it would be hard to remove them rapidly, and strong high inertia air flow has the power to re-ingest them back into the air stream towards the cabin. In most cases, the higher the airflow through evaporator 54 the larger the water droplets (in both size and quantity) that get condensed and re-enter the cool air flowing into the cabin.

A solution for reducing the water droplet content remaining in the cool air output by an ECU may include increasing the size of the evaporator, which may help slow the air flow and provide a larger footprint for humidity removal, preventing more water droplets from re-entering the airflow in the cool air outputting the ECU. However, increasing the size of the evaporator is not a feasible solution for many application, such as aircraft or even car applications, in which size limitations are very strict, and space is at a premium. Increasing the size of the evaporator would cause an increase in price, weight, and space requirements, which in this application is not a desirable nor viable solution.

As such, in current systems, current ECU systems, while providing functionality to cool down or heat ambient air, are very limited in their ability to remove humidity from the airflow, leaving a significant number of water droplets within the airflow, which can lead to many problems as previously mentioned.

### SUMMARY

The present disclosure achieves technical advantages as systems and methods that provide passive dehumidifiers for environmental control units (ECUs). In particular embodiments, a passive dehumidifier is provided that can include a plenum. A collector wall may be disposed within the interior of the plenum and may be configured to collect water droplets on at least one surface of the collector wall. An airflow control channel may be disposed between an intake and outtake of the passive dehumidifier. In some embodiments, the airflow control channel may be defined by the walls of the plenum and/or at least one collector wall. In embodiments, the airflow control channel may be configured to decrease the inertia of the airflow using volume expansion, and to change a direction of the airflow entering the intake from a first direction to a second direction. The change in the direction of the airflow from the first direction to the second direction may be configured to prevent at least a portion of water droplets present in the airflow from following the airflow into the second direction thereby causing the at least a portion of the water droplets to impinge against the at least one surface of the collector wall. The water droplets collected by the collector wall may be routed (e.g., using gravity in some embodiments) and drained from the passive dehumidifier through a drain. In embodiments, the water droplets collected by the collector wall may be routed from the at least one surface to the drain using a screen mesh. In some embodiments, the least one surface of the collector wall, one or more surfaces of the control channel, and/or the surface of the screen mesh can be a hydrophilic surface.

In embodiments, the passive dehumidifier of embodiments may receive an airflow intake from the evaporator of an ECU, and may allow removal of water droplets remaining in the airflow output by the ECU. The water droplets removed by the passive dehumidifier of embodiments may represent water droplets having a high Stokes number (e.g., greater than 1). For example, the configuration of the passive dehumidifier of embodiments may control the direction of the airflow containing the water droplets, causing the airflow to experience volume expansion and changing the direction from a first direction to a second direction. The change from the first to the second direction may be sharp enough (e.g., greater than 90 degrees) such that the water droplets may not be able to follow the airflow change due to the high inertia of the water droplets and/or due to centrifugal force due to the change in direction and may instead be directed towards the collector wall, against which the water droplets may impinge and be collected. Configuring the collector wall as a hydrophilic surface may further facilitate collection of the water droplets on the collector wall by allowing the allowing the impinged water droplets to form a liquid film upon impact on the collector wall. The film may collapse due to gravity and may be drained out through a hydrophilic screen mesh under the collector wall. In this manner, a passive dehumidifier implemented in accordance with embodiments of the present disclosure may provide further humidity removal from an airflow and may help address the deficiencies of current ECU systems as described above. Advantageously, such a passive dehumidifier has application in numerous industries requiring dehumidification. For example, the passive dehumidifier can provide the aforementioned benefits to temperature control systems in the automotive, aerospace, data center, HVAC, and robotics industries, among others.

It is an object of the disclosure to provide a passive dehumidifier for ECUs. It is a further object of the disclosure to provide a method of removing water droplets from an airflow and a method of manufacturing a passive dehumidifier for ECUs. These and other objects are provided by the present disclosure, including at least the following embodiments.

In one particular embodiment, a passive dehumidifier for ECUs is provided. The passive dehumidifier includes a collector wall disposed within an interior of the passive dehumidifier and configured to collect water droplets on at least one surface of the collector wall, and an airflow control channel disposed between an intake and outtake of the passive dehumidifier. In embodiments, the airflow control channel can be configured to change a direction of an airflow entering the intake from a first direction to a second direction, and the change in the direction of the airflow can be configured to prevent at least a portion of water droplets present in the airflow from following the airflow into the second direction causing the at least a portion of the water droplets to impinge against the at least one surface of the collector wall. The passive dehumidifier also includes a drain configured to drain the water droplets collected by the collector wall from the passive dehumidifier.

In another embodiment, a method of removing moisture (e.g., water droplets) from an airflow is provided. The method includes receiving the airflow at an intake of a passive dehumidifier and causing a change in a direction of the airflow entering the intake from a first direction to a second direction. In embodiments, the change in the direction of the airflow can be configured to prevent at least a portion of water droplets present in the airflow from following the airflow into the second direction causing the at least a portion of the water droplets to impinge against at least one surface of a collector wall disposed within an interior of the passive dehumidifier and configured to collect the at least a portion of the water droplets on at least one surface of the collector wall. The method also includes routing the at least a portion of the water droplets collected on the at least one surface of the collector wall to a drain of the passive dehumidifier.

In still another embodiment, a method of manufacturing a passive dehumidifier for ECUs is provided. The method includes disposing a collector wall within an interior of the passive dehumidifier. In embodiments, the collector wall can be configured to collect moisture (e.g., water droplets) on at least one surface of the collector wall. The method also includes disposing an airflow control channel between an intake and outtake of the passive dehumidifier. In embodiments, the airflow control channel can be configured to change a direction of an airflow entering the intake from a first direction to a second direction, and the change in the direction of the airflow can be configured to prevent at least a portion of water droplets present in the airflow from following the airflow into the second direction causing the at least a portion of the water droplets to impinge against the at least one surface of the collector wall. The method also includes configuring a drain to drain the water droplets collected by the collector wall from the passive dehumidifier.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates an example of a typical environmental control unit (ECU) configured to condition intake air and remove humidity from the intake air.

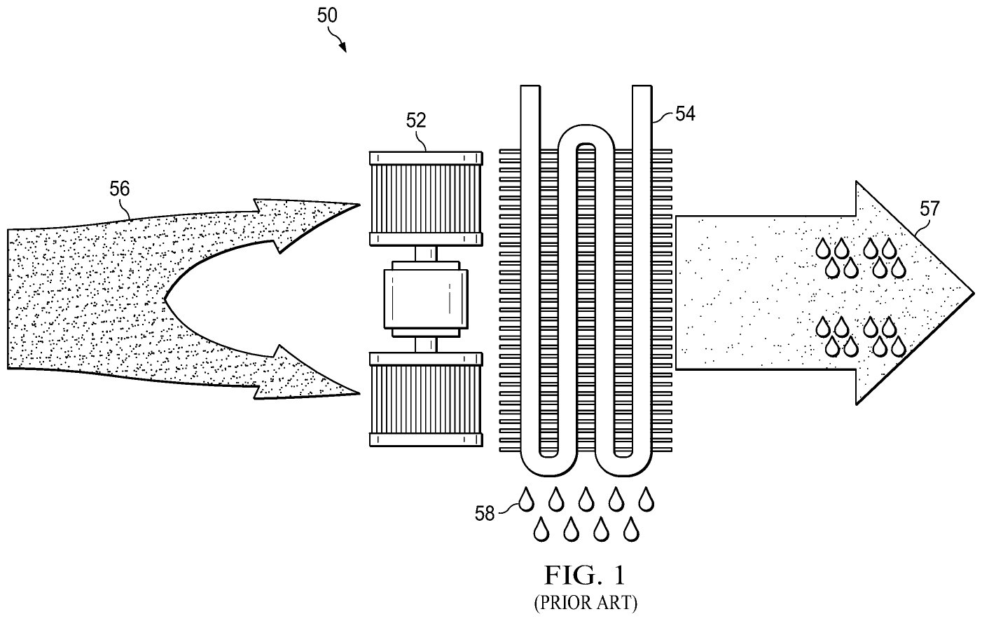

FIG. 2 is a diagram of an exemplary passive dehumidifier configured with capabilities and functionality in accordance with embodiments of the present disclosure.

FIG. 3A is a diagram of an exemplary implementation of a passive dehumidifier configured with capabilities and functionality in accordance with embodiments of the present disclosure.

FIG. 3B shows another view of the exemplary implementation of a passive dehumidifier configured with capabilities and functionality in accordance with embodiments of the present disclosure.

FIG. 3C shows yet another view of the exemplary implementation of a passive dehumidifier configured with capabilities and functionality in accordance with embodiments of the present disclosure.

FIG. 4 is a diagram of exemplary operations of a passive dehumidifier in accordance with embodiments of the present disclosure.

FIG. 5 is a high-level flow diagram of a method for removing water droplets from an airflow in accordance with embodiments of the present disclosure.

FIG. 6 shows a high-level flow diagram of exemplary operations for manufacturing a passive dehumidifier configured in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Various embodiments of the present disclosure are directed to passive dehumidifiers for environmental control units (ECUs). In particular, the present disclosure provides for a passive dehumidifier with functionality that addresses deficiencies of current ECUs. For example, the present disclosure provides for a passive dehumidifier that may allow removal of moisture (e.g., water droplets, water vapor, etc.) remaining in the airflow output by an ECU. In embodiments, the passive dehumidifier may include a plenum. An airflow may be received at an intake of the plenum from an evaporator of the ECU. The water droplets removed by the passive dehumidifier of embodiments may represent water droplets having a high Stokes number (e.g., greater than 1). For example, the configuration of the passive dehumidifier of embodiments may control the direction of the airflow containing the moisture, causing the airflow to experience volume expansion and changing the direction from a first direction to a second direction. The change from the first to the second direction may be sharp enough (e.g., greater than 90 degrees) such that the water droplets may not be able to follow the airflow change due to the high inertia of the water droplets and/or due to centrifugal force due to the change in direction and may instead be directed towards the collector wall, against which the water droplets may impinge and be collected. Configuring the collector wall as a hydrophilic surface may further facilitate collection of the water droplets on the collector wall by allowing the impinged water droplets to form a liquid film upon impact on the collector wall. The film may collapse due to gravity and may be drained out through a hydrophilic screen mesh under the collector wall.

It is noted that although the present disclosure may focus on a particular application in which the passive dehumidifier of embodiments may be used with an ECU of a vehicle (e.g., an aircraft (e.g., a rotary wing aircraft (e.g., a helicopter, vertical takeoff and landing (VTOL) aircraft, etc.), as part of a main propeller of a fixed wing aircraft, etc.)), this is for illustrative purposes and it is not intended to be limiting in any way. Indeed, the passive dehumidifier of embodiments may be used in other applications involving humidity removal from an airflow. For example, in some applications, the passive dehumidifier of embodiments may be configured to remove moisture or humidity from an airflow that may flow through an engine, such as an engine of a vehicle (e.g., an aircraft, car, or other type of vehicle) or device (e.g., other type of device in which an engine may be employed).

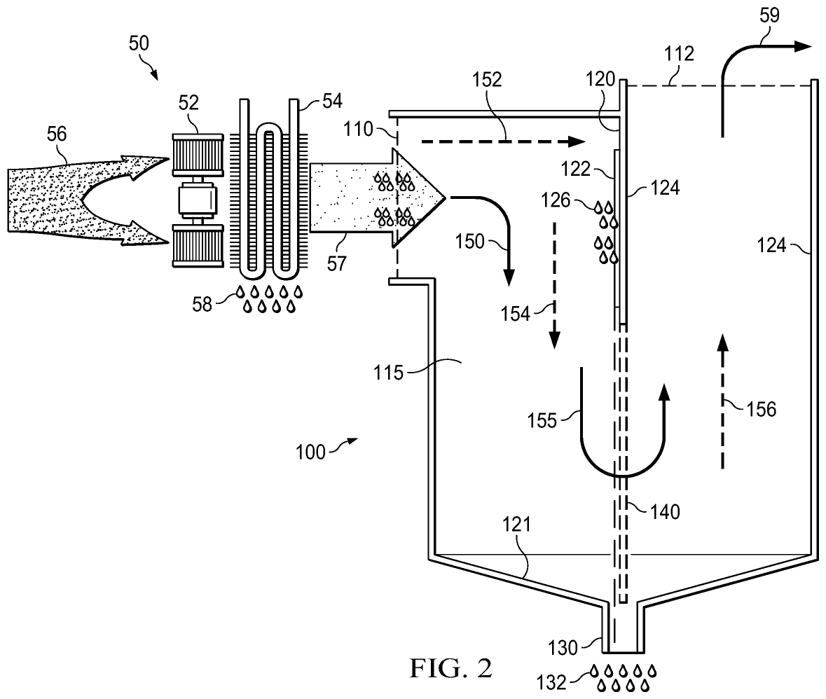

FIG. 2 is a diagram of an exemplary passive dehumidifier 100 configured with capabilities and functionality in accordance with embodiments of the present disclosure. As shown in FIG. 2, passive dehumidifier 100 may be implemented as a plenum configured to cooperatively operate with ECU 50 to provide supplemental dehumidification to an airflow being conditioned by ECU 50. In some embodiments, passive dehumidifier 100 may be part of ECU 50, may be functionally coupled to the output of ECU 50, or may be a standalone component.

It is noted that, in some embodiments, passive dehumidifier 100 may operate without an ECU, and in these embodiments may operate to remove moisture, in accordance with embodiments of the present disclosure, from an airflow provided to the intake of passive dehumidifier 100. As such, it should be appreciated that description herein of the operation of passive dehumidifier 100 in conjunction with ECU 50 is not intended to be limiting, and it is merely for illustrative purposes.

As shown in FIG. 2, passive dehumidifier 100 may include airflow control channel 115, collector wall 120, and drain 130. In embodiments, these components of passive dehumidifier 100 may cooperatively operate to provide dehumidification of an airflow provided as an input to passive dehumidifier 100.

In embodiments, passive dehumidifier 100 may also include intake 110 through which an airflow 57 may be received as an input into passive dehumidifier 100. In embodiments, airflow 57 may represent an airflow to be dehumidified by passive dehumidifier 100. In some embodiments, airflow 57 may be an airflow output from ECU 57, such as an airflow of air conditioned (e.g., cooled, heated, and/or partially dehumidified) by ECU 50, which may contain moisture (e.g., water droplets, water vapor, etc.) that were not removed from airflow 57 by ECU 50. In embodiments, some of the water droplets contained in airflow 57 may have a high Stokes number (e.g., a Stokes number greater than 1).

In embodiments, passive dehumidifier 100 may also include outtake 112 through which a dry airflow 59 may be routed out of passive dehumidifier 100 as an output. In embodiments, dry airflow 59 may be provided to a vehicle cabin, such as an aircraft cabin (e.g., to cool or heat the cabin, to defog a canopy, to cool or heat instruments, etc.). In embodiments, dry airflow 59 may represent an airflow (e.g., airflow 57) from which water droplets have been removed by operation of passive dehumidifier 100.

In embodiments, collector wall 120 may be configured to collect water droplets impinging on one or more surfaces of collector wall 120. For example, collector wall 120 may include one or more surfaces configured to receive water droplets 126 that may impinge upon the one or more surfaces and to collect the water droplets. The collected water droplets 126 may accumulate on the one or more surfaces of collector wall 120 and may form a liquid film 122. At some point, sufficient water droplets may accumulate on the one or more surfaces of collector wall 120 such that liquid film 122 may increase to a point that liquid film 122 may collapse due to the gravity force being acted upon liquid film 122. In this case, liquid film 122 may roll, fall, or otherwise run down into drain 130, from which water 132 may be drained out of passive dehumidifier 100.

In some embodiments, the one or more walls of collector wall 120 may include one or more walls of the plenum implementing passive dehumidifier 100. For example, the internal walls of passive dehumidifier 100 may be configured as collector walls of collector wall 120. In this manner, as airflow 57 can be routed through the interior of passive dehumidifier 100 (e.g., through airflow control channel 115), water droplets in airflow 57 may be routed toward various surfaces of the interior of passive dehumidifier 100 to facilitate collection of those water droplets at the various collector surfaces. For example, in embodiments, surfaces 124 of passive dehumidifier 100 may be part of collector wall 120.

In embodiments, the shape of collector wall 120 may be based on design requirements of passive dehumidifier 100. For example, in some embodiments, collector wall 120 may be implemented as a flat wall, including one or more flat surfaces.

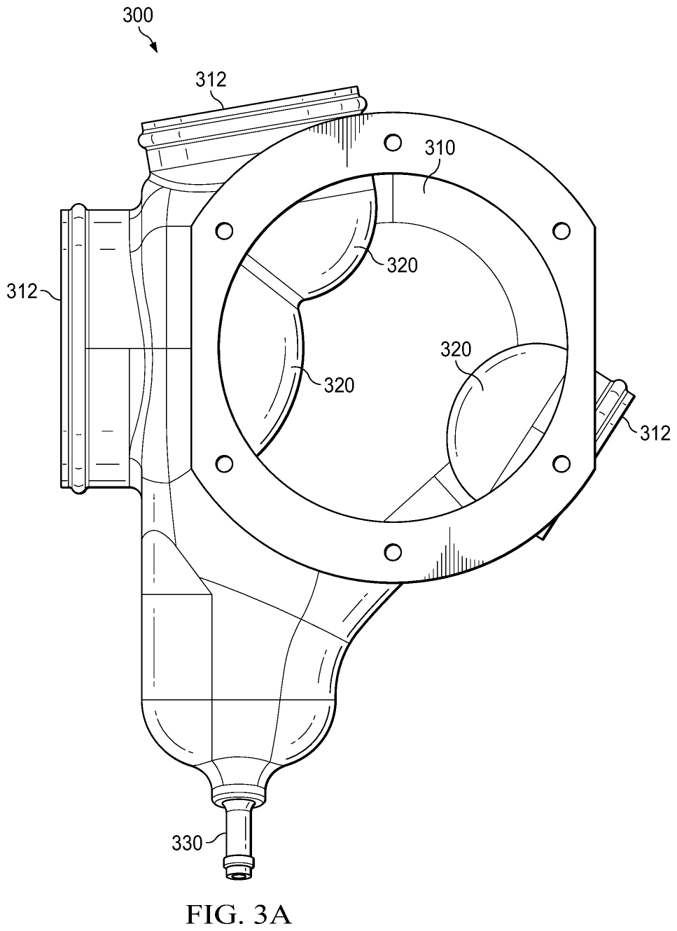

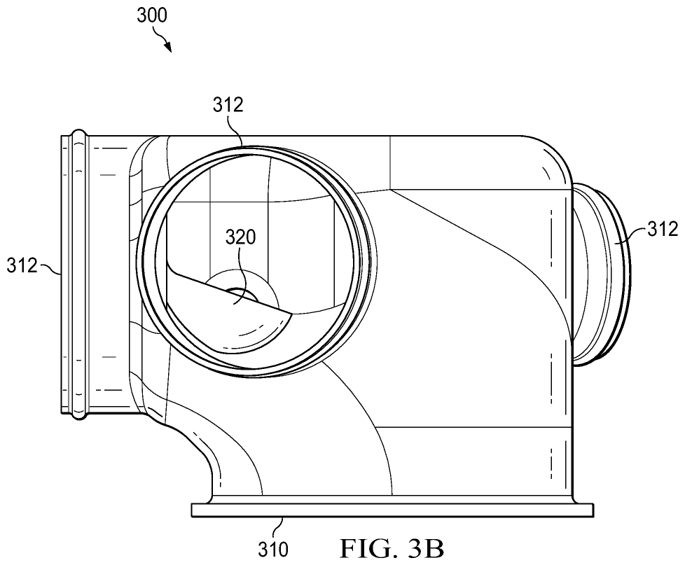

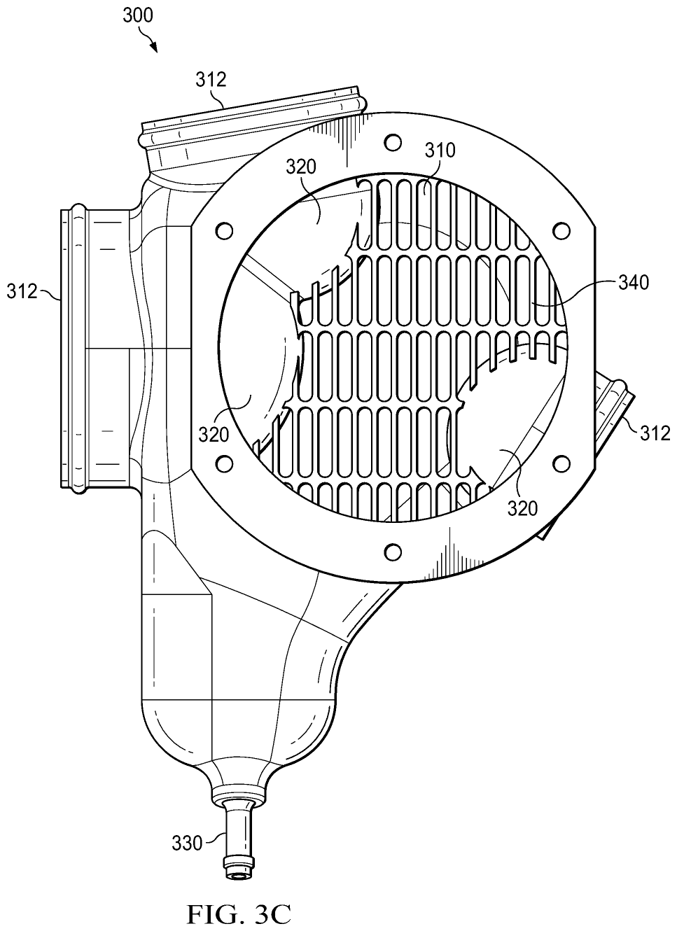

In some other embodiments, collector wall 120 may be implemented having a spherical shape, such as a dome, or a partial dome (e.g., a half dome). For example, FIG. 3A is a diagram of an exemplary implementation of passive dehumidifier 300 configured with capabilities and functionality in accordance with embodiments of the present disclosure. In the particular example illustrated in FIG. 3A, passive dehumidifier 300 may include a plurality of outtakes 312, and single intake 310, a drain 330, and a plurality of collector walls 320. In embodiments, passive dehumidifier 300 may be designed for use in aircraft applications. In this example, each of collector walls 320 may be disposed to shield a respective outtake 312. In this case, each of collector walls 320 may be cover at least a portion of the respective outtake 312.

In this example of FIG. 3A, collector wall 320 may be implemented as a half dome having a round portion facing intake 310 and another portion facing outtake 312. In embodiments, the other portion facing outtake 312 may have scoop shape (e.g., concave or curved into the dome) or may have a flat face. FIG. 3B, which shows another view of the exemplary implementation of passive dehumidifier 300 configured with capabilities and functionality in accordance with embodiments of the present disclosure, shows another view of collector wall 320 illustrating the half-dome shape of collector wall 320.

With reference back to FIG. 2, in embodiments, the one or more surfaces of collector wall 120 may be hydrophilic. For example, in embodiments, the one or more surfaces of collector wall 120 may be made or constructed of a hydrophilic material (e.g., aluminum, etc.) and/or could be coated or painted with a hydrophilic coat or paint.

In embodiments, the hydrophilicity of the one or more surfaces of collector wall 120 may increase the likelihood that a water droplet impinging upon the one or more surfaces of collector wall 120 will attach to (e.g., be collected by) the one or more surfaces of collector wall 120, rather than bouncing off the one or more surfaces of collector wall 120 (or being pulled off the one or more surfaces of collector wall 120) and/or re-entering back into airflow 57. Furthermore, the hydrophilicity of the one or more surfaces of collector wall 120 may facilitate the coalescing or aggregating of water droplets 126 collected on the one or more surfaces of collector wall 120 into liquid film 122. As noted above, once liquid film 122 reaches a size exceeding a threshold size (e.g., a volume, weight, or number of water droplets threshold), liquid film may drop or fall down into drain 130 to be drained out of passive dehumidifier 100.

It is again noted that, in some embodiments, the one or more surfaces of collector wall 120 may include all or most of the interior surfaces of passive dehumidifier 100, in which case, in embodiments, all or most of the interior surfaces of passive dehumidifier 100 may be configured as hydrophilic surfaces in accordance with embodiments herein.

In some optional embodiments, passive dehumidifier 100 may include screen mesh 140. Screen mesh 140 may be configured to facilitate routing or guiding liquid film 122 from collector wall to drain 130, while allowing airflow 57 to pass though airflow control channel 115. For example, in embodiments, screen mesh 140 may be disposed within airflow control channel 115, and may be functionally coupled to collector wall 120 and drain 130. In this manner, screen mesh 140 may operate to route liquid film 122 from collector wall 120 to drain 130 to be drained out of passive dehumidifier 100. For example, once liquid film 122 reaches a size exceeding a threshold size, liquid film may begin falling down due to gravity and may be guided by screen mesh 140 into drain 130.

In embodiments, screen mesh 140 may be partially or entirely hydrophilic. For example, at least one surface of screen mesh 140 may be a hydrophilic, which may facilitate liquid film 122 being routed through screen mesh 140, and which may also function to remove water droplets from airflow 57 as airflow 57 passes through screen mesh 140. For example, screen mesh 140 may be disposed within airflow control channel 115 and within the path of airflow 57. Screen mesh 140 may be configured as a screen mesh allowing airflow 57 to flow through screen mesh 140. As airflow 57 flows through screen mesh 140, water droplets remaining within airflow 57 when airflow 57 passes through screen mesh 140 may impinge upon the hydrophilic surface of screen mesh 140 and may be collected on the hydrophilic surface of screen mesh 140. In this manner, screen mesh 140 may operate to guide liquid film 122 from collector wall 120 to drain 130 and to remove water droplets from airflow 57 while allowing airflow 57 to flow through airflow control channel 115.

In embodiments, airflow control channel 115 may be configured to route, guide, and/or control the direction of airflow 57 within the plenum of passive dehumidifier 100. Controlling the direction of airflow 57 may include causing airflow 57 to sharply turn from a first direction to a second direction, which may cause water droplets in airflow 57 to continue in the first direction, as water droplets may not be able to turn as fast as the air in airflow 57, separating from airflow 57 due to centrifugal force. The separated water droplets may then impinge upon the interior surfaces of passive dehumidifier 100, which may include collector wall 120. In some embodiments, the directional change may be a directional change greater than ninety degrees, or a directional change sharp enough to prevent water droplets in airflow 57 from being able to follow the directional change of airflow 57 and instead impinge against collector wall 120.

For example, airflow control channel 115 may be configured with a direction change 150 configured to cause airflow 57 entering intake 110 to change from direction 152 to direction 154. In embodiments, direction change 150 may be an approximately ninety degrees change. In this case, airflow 57 may be forced to flow in direction 154 after direction change 150. However, water droplets 126 present in airflow 57 before direction change 150 may have a high Stokes number (e.g., a Stokes number greater than 1), in which case these water droplets 126 may be unable to follow direction change 150 due to the centrifugal force experienced by these water droplets 126 based on the size and weight of the water droplets 126. In this case, water droplets 126 may continue traveling in direction 152 toward collector wall 120 and may impinge on one or more surfaces of collector wall 120. These water droplets 126 may collect on collector wall 120 and may aggregate onto liquid film 122, which may be subsequently drained from drain 130 as described herein.

In some embodiments, airflow control channel 115 may be configured with a second direction change 155, which may be configured to cause airflow 57 to change from direction 154 to direction 156. In embodiments, direction change 155 may be an approximately 180 degrees change. In this case, airflow 57 may be forced to flow in direction 156 after direction change 155, but water droplets remaining in airflow 57 after the first direction change 150 may be unable to follow direction change 155 due to the higher centrifugal force experienced by the approximately 180-degree directional change. In this example, these remaining water droplets may continue in direction 154 toward surface 121 of collector wall 120 and may impinge on surface 121 of collector wall 120, where these remaining water droplets may be collected and subsequently drain out of passive dehumidifier 100 via drain 130. In some embodiments, airflow 57 may pass through screen mesh 140 during direction change 155.

In embodiments, airflow control channel 115 may be configured to route dry airflow 59, after direction changes 150 and 155, toward outtake 112, from which dry airflow 59 may exit passive dehumidifier 100 as dehumidified air. In embodiments, dry airflow 59 may be routed to a cabin, such as an aircraft cabin (e.g., to cool or heat the cabin, to defog a canopy, to cool or heat instruments, etc.). In embodiments, dry airflow 59 may represent an airflow (e.g., airflow 57) from which water droplets have been removed by operation of passive dehumidifier 100.

In embodiments, airflow control channel 115 may be configured to decrease the inertia of airflow 57 upon entering intake 110 due to sudden volume expansion. By reducing the inertia of airflow 57, airflow control channel 115 may facilitate direction change 150 and/or direction change 155 by reducing inertial of the air in airflow 57, which may make it easier for airflow 57 to make the directional change. In embodiments, the sudden volume expansion may be provided by configuring at least a portion of airflow control channel 115 to have a larger cross-sectional area than the cross-sectional area of the channel from which airflow 57 is output from ECU 50. In this manner, airflow 57 may experience a sudden volume expansion upon entering passive dehumidifier 100.

In embodiments, airflow control channel 115 may be defined by the interior configuration of passive dehumidifier 100. For example, as shown in FIG. 2, airflow control channel 115 may be defined by the interior walls of passive dehumidifier 100 and/or collector wall 120. In embodiments, control channel 115 may be disposed between intake 110 and outtake 112 of passive dehumidifier 100.

As noted above, FIGS. 3A-3C show a particular implementation of a passive dehumidifier that may be used in aircraft applications. In this example, passive dehumidifier 300 may be implemented as a plenum including a single intake 310, a plurality of outtakes 312, a drain 330, and a plurality of collector walls 320. In this example, each of collector walls 320 may be disposed to shield a respective outtake 312, and may be configured as a half-dome shield. In this case, each of collector walls 320 may cover at least a portion of the respective outtake 312. FIG. 3B shows a side view of passive dehumidifier 300 normal to outtake 312. FIG. 3C shows a front view of passive dehumidifier 300 normal to intake 310, and illustrates an implementation of passive dehumidifier 300 that includes screen mesh 340 disposed within the interior (e.g., the airflow control channel) of passive dehumidifier 300, coupling one or more of the plurality of collector walls 320 to drain 330.

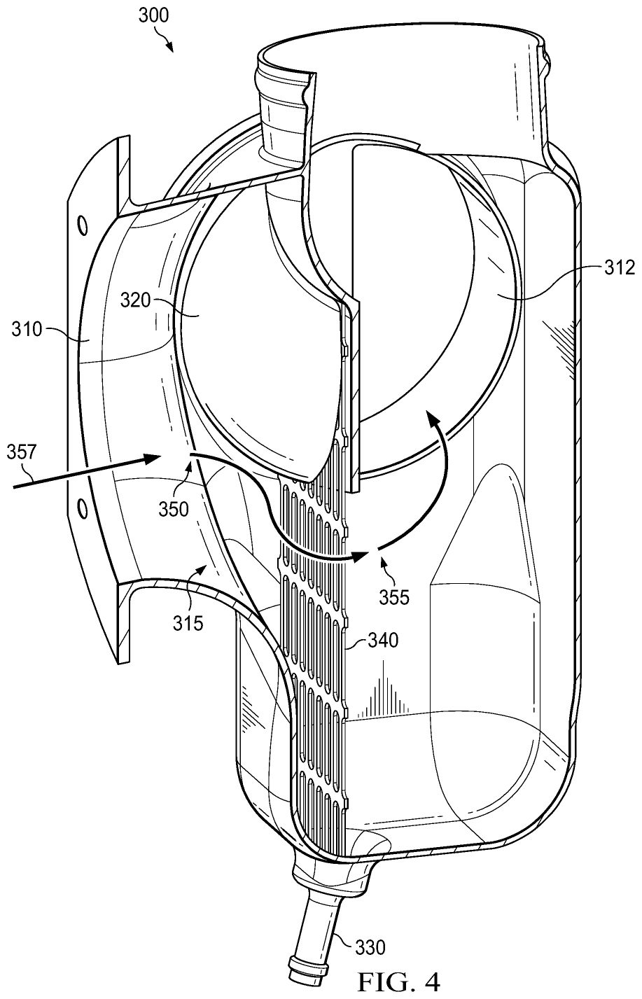

FIG. 4 is a diagram of exemplary operations of passive dehumidifier 300 in accordance with embodiments of the present disclosure. As noted above, passive dehumidifier 300 may be configured for aircraft applications and may be implemented as a plenum including an intake 310, outtake 312, drain 330, collector wall 320, and screen mesh 340.

In the example illustrated in FIG. 4, during operation, airflow 357 may enter passive dehumidifier 300 through intake 310. Upon entering airflow control channel 315 of passive dehumidifier 300, airflow 357 may experience a reduction in inertia due to sudden volume expansion. After sudden volume expansion, airflow 357 may be caused to sharply change direction at 350 (e.g., a change of approximately ninety degrees) around collector wall 320, which may prevent moisture (e.g., water droplets, water vapor, etc.) present in airflow 357 from following the directional change at 350 and instead continue, at least substantially, in the original direction and impinge upon collector wall 320. The water droplets may be collected on the surface of collector wall 320 shielding outtake 312 (as well as other interior surfaces of passive dehumidifier 300) and, due to the hydrophilicity of collector wall 320 may aggregate on the surface of collector wall 320 forming a liquid film. When the liquid film formed over collector surface 320 reaches a threshold size, the liquid film may slide or fall down, due to gravity and may be guided (e.g., by screen mesh 340) to drain 330 from which the water in the liquid film may be drained out of passive dehumidifier 100. In embodiments airflow 357 may continue flowing through airflow control channel 315 and may experience a second directional change at 355 of approximately 180 degrees. This second directional change may cause water droplets remaining in airflow 357 to separate from airflow 357 and impinge and be collected on the interior surfaces (e.g., hydrophilic interior surfaces) of airflow control channel 315, which may then be routed to drain 330.

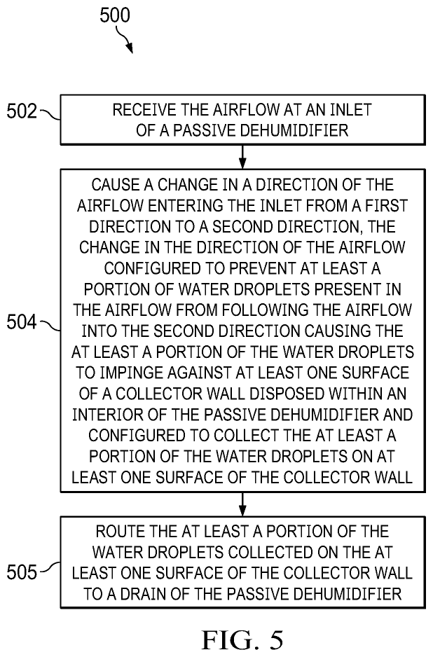

FIG. 5 is a high-level flow diagram of a method 500 for removing moisture (e.g., water droplets, water vapor, etc.) from an airflow in accordance with embodiments of the present disclosure. In embodiments, the steps of method 500 may be implemented using a passive dehumidifier (e.g., passive dehumidifier 100 and/or 300 of FIGS. 2-4).

At block 502, an airflow is received at an intake of a passive dehumidifier. For example, in embodiments, an airflow (e.g., airflow 57 and/or airflow 357 of FIGS. 2-4) may be received at an intake (e.g., intake 110 and/or intake 310 of FIGS. 2-4) of a passive dehumidifier (e.g., passive dehumidifier 100 and/or 300 of FIGS. 2-4) according to configuration and functionality described with respect to embodiments of the present disclosure. In embodiment, upon the airflow entering the passive dehumidifier, the airflow may experience a reduction in inertia due to sudden volume expansion.

At block 504 a change in a direction of the airflow entering the intake from a first direction to a second direction can be facilitated. For example, an airflow control channel (e.g., airflow control channel 115 and/or airflow control channel 315 of FIGS. 2-4) may be configured and/or used to cause a change in a direction of the airflow a first direction to a second direction according to configuration and functionality described with respect to embodiments of the present disclosure. In embodiments the change in the direction of the airflow may be configured to prevent at least a portion of water droplets present in the airflow from following the airflow into the second direction causing the at least a portion of the water droplets to impinge against at least one surface of a collector wall disposed within an interior of the passive dehumidifier and configured to collect the at least a portion of the water droplets on at least one surface of the collector wall.

At block 506, the at least a portion of the water droplets collected on the at least one surface of the collector wall are routed to a drain of the passive dehumidifier. For example, the at least a portion of the water droplets collected on the at least one surface of the collector wall may be routed to a drain (e.g., drain 130 and/or drain 330 of FIGS. 2-4) to be drained out of the passive dehumidifier according to configuration and functionality described with respect to embodiments of the present disclosure.

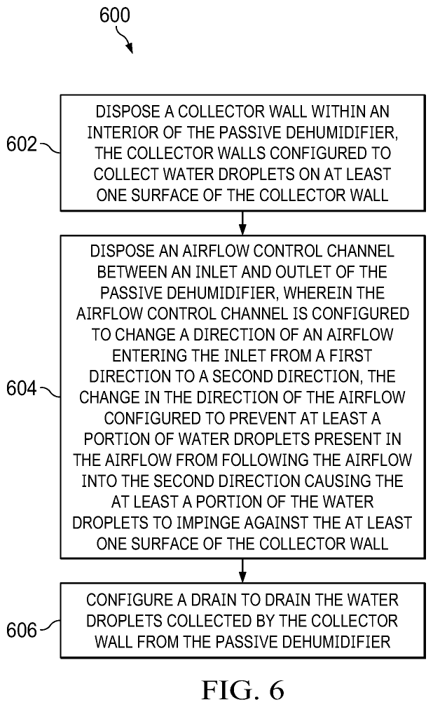

A method of manufacturing a passive dehumidifier in accordance with embodiments of the present disclosure will now be discussed with respect to FIG. 6. FIG. 6 shows an exemplary flow diagram 600 of operations for manufacturing a passive dehumidifier in accordance with embodiments of the present disclosure. For example, the steps illustrated in the example blocks shown in FIG. 6 may be performed to manufacture passive dehumidifier 100 and/or passive dehumidifier 300, as illustrated in FIGS. 2-4, according to embodiments herein.

At block 602, a collector wall can be disposed within an interior of the passive dehumidifier. For example, a collector wall (e.g., collector wall 120 and/or collector wall 320 of FIGS. 2-4) can be disposed within an interior of the passive dehumidifier (e.g., passive dehumidifier 100 and/or 300 of FIGS. 2-4) according to configuration and functionality described with respect to embodiments of the present disclosure. In embodiments, the collector walls may be configured to collect water droplets on at least one surface of the collector wall.

At block 604, an airflow control channel can be disposed between an intake and outtake of the passive dehumidifier. For example, an airflow control channel (e.g., airflow control channel 115 and/or airflow control channel 315 of FIGS. 2-4) can be disposed between an intake and outtake of the passive dehumidifier according to configuration and functionality described with respect to embodiments of the present disclosure. In embodiments, the airflow control channel is configured to change a direction of an airflow entering the intake from a first direction to a second direction, and the change in the direction of the airflow can be configured to prevent at least a portion of moisture (e.g., water droplets, water vapor, etc.) present in the airflow from following the airflow into the second direction causing the at least a portion of the water droplets to impinge against the at least one surface of the collector wall.

At block 606, a drain can be configured to drain the water droplets collected by the collector wall from the passive dehumidifier. For example, a drain (e.g., drain 130 and/or drain 330 of FIGS. 2-4) may be configured to drain the water droplets collected by the collector wall from the passive dehumidifier according to configuration and functionality described with respect to embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are in-tended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A passive dehumidifier, comprising:
a collector wall disposed within an interior of the passive dehumidifier and configured to collect moisture on at least one surface of the collector wall;
an airflow control channel disposed between an intake and outtake of the passive dehumidifier, wherein the airflow control channel is configured to change a direction of an airflow entering the intake from a first direction to a second direction, the change in the direction of the airflow configured to prevent at least a portion of the moisture present in the airflow from following the airflow into the second direction causing the at least a portion of the moisture to impinge against the at least one surface of the collector wall; and
a drain configured to drain the moisture collected by the collector wall from the passive dehumidifier.

2. The passive dehumidifier of claim 1, wherein the airflow control channel is configured to provide volumetric expansion of the airflow entering the intake to reduce the inertia of the airflow and reduce the speed of the airflow.

3. The passive dehumidifier of claim 1, further comprising a screen mesh configured to facilitate routing the moisture collected by the collector wall to the drain.

4. The passive dehumidifier of claim 3, wherein the screen mesh is functionally coupled to the at least one surface of the collector wall and the drain.

5. The passive dehumidifier of claim 1, wherein an angle of the change in the direction of the airflow entering the intake from the first direction to the second direction is at least ninety degrees.

6. The passive dehumidifier of claim 5, wherein the airflow control channel is further configured to change the direction of the airflow from the second direction to a third direction, the change in the direction of the airflow from the second direction to the third direction configured to prevent at least a further portion of the moisture remaining the airflow flowing in the second direction from following the airflow into the third direction causing the further portion of the moisture to impinge against the at least one surface of the collector wall.

7. The passive dehumidifier of claim 6, wherein an angle of the change in the direction of the airflow from the second direction to the third direction is greater than the angle of the change in the direction of the airflow entering the intake from the first direction to the second direction.

8. The passive dehumidifier of claim 1, wherein the least one surface of the collector wall is a hydrophilic surface.

9. The passive dehumidifier of claim 1, wherein the collector wall is disposed over at least a portion of the outtake of the passive dehumidifier.

10. The passive dehumidifier of claim 9, wherein the collector wall is shaped as a half dome covering the at least a portion of the outtake of the passive dehumidifier.

11. A method of removing moisture from an airflow, comprising:
receiving the airflow at an intake of a passive dehumidifier;
causing a change in a direction of the airflow entering the intake from a first direction to a second direction, the change in the direction of the airflow configured to prevent at least a portion of moisture present in the airflow from following the airflow into the second direction causing the at least a portion of the moisture to impinge against at least one surface of a collector wall disposed within an interior of the passive dehumidifier and configured to collect the at least a portion of the moisture on at least one surface of the collector wall; and
routing the at least a portion of the moisture collected on the at least one surface of the collector wall to a drain of the passive dehumidifier.

12. The method of claim 11, further comprising:
causing a volumetric expansion of the airflow entering the intake to reduce the inertia of the airflow and reduce the speed of the airflow.

13. The method of claim 11, wherein routing the at least a portion of the moisture collected on the at least one surface of the collector wall to the drain of the passive dehumidifier includes using a screen mesh functionally coupled to the at least one surface of the collector wall and the drain to facilitate routing the at least a portion of the moisture collected by the collector wall to the drain.

14. The method of claim 11, wherein an angle of the change in the direction of the airflow entering the intake from the first direction to the second direction is at least ninety degrees.

15. The method of claim 14, further comprising:
causing a change in the direction of the airflow from the second direction to a third direction, the change in the direction of the airflow from the second direction to the third direction configured to prevent at least a further portion of the moisture remaining the airflow flowing in the second direction from following the airflow into the third direction causing the further portion of the moisture to impinge against the at least one surface of the collector wall.

16. The method of claim 15, wherein an angle of the change in the direction of the airflow from the second direction to the third direction is greater than the angle of the change in the direction of the airflow entering the intake from the first direction to the second direction.

17. The method of claim 11, wherein the least one surface of the collector wall is a hydrophilic surface.

18. The method of claim 11, wherein the collector wall is disposed over at least a portion of the outtake of the passive dehumidifier.

19. The method of claim 18, wherein the collector wall is shaped as a half dome covering the at least a portion of the outtake of the passive dehumidifier.

20. A method of manufacturing a passive dehumidifier, comprising:
disposing a collector wall within an interior of the passive dehumidifier, the collector wall configured to collect moisture on at least one surface of the collector wall;
disposing an airflow control channel between an intake and outtake of the passive dehumidifier, wherein the airflow control channel is configured to change a direction of an airflow entering the intake from a first direction to a second direction, the change in the direction of the airflow configured to prevent at least a portion of moisture present in the airflow from following the airflow into the second direction causing the at least a portion of the moisture to impinge against the at least one surface of the collector wall; and
configuring a drain to drain the moisture collected by the collector wall from the passive dehumidifier.
